(19) United States
(12) Patent Application Publication
(10) Pub. No.: US 2009/0305200 A1
(43) Pub. Date: Dec. 10, 2009

(54) Hybrid E-Learning Course Creation and Syndication

(76) Inventors: Joseph D. Gorup, WHEATON, IL (US); Jeffrey A. Ford, AURORA, IL (US)

Correspondence Address: Garthwaite PLLC, 10155 Winther Road, Bainbridge Island, WA, 98110, US

(21) Appl. No.: 12/135,195

(22) Filed: Jun. 8, 2008

(51) Int. Cl. G09B 19/00

(52) U.S. Cl. 434/118

(57) ABSTRACT

The disclosed invention is directed to a method and system which allows publishers to create hybrid elearning courses and to publish the courses to a variety of environments including to an LMS, a web interface, or a CD-ROM. Through a “syndication” process, the hybrid elearning courses are associated with consuming organizations downstream of the publisher; such consuming organizations and/or roles within such organizations may be allowed to edit or customize those portions of the courses which have been labeled as “consumer editable.”

### BACKGROUND

E-learning or elearning refers to computer assisted learning. The term implies use of computer-based tools to create and disseminate instructional material to a learning audience, whether grade- or high-school students, graduate students, workers receiving job-related training or similar (collectively referred to herein as “learners”). As computers now commonly facilitate two-way text as well as synchronous and asynchronous audiovisual communication, e-learning systems now also frequently include two-way computer-mediated communication between instructors and learners in the context of the instructional material. A simple example of an e-learning system is a CD-ROM containing text, audiovisual, and other information relating to a subject, often arranged in a ordered set of HTML documents. If the material is hosted on a website, the website might include a chat and/or email forum to facilitate interaction between the instructor and learners, webpages specific to particular lessons, and automated and semi-automated tools to evaluate student work, such as a webpage which hosts a test and which provides the teacher and/or student with results of student performance on the test.

More sophisticated learning management systems (“LMS”) and/or learning content management systems (“LCMS”) attempt to provide a central repository of reusable content, interoperate with or provide learner registration services, performance tracking and reporting to human resources or school registrar systems. In general, an LMS is centered around the management of student or “learner” records while an LCMS is content-centric. Whereas an LMS would track (amongst other things), a student's transcript the LCMS would track the usage of say, a piece of text, or a graphic. It is said (and debated) that the LCMS model includes more functions around the goal of treating instructional content as “learning objects” which may be reused and “repurposed” for different instructional contexts.

The art has demonstrated elearning course authoring tools which may be grouped into two categories, from simple to complex: relatively simple template-driven authoring systems typically used by individuals and small groups to complex LMS- and/or LCMS-based systems generally used by large organizations.

The template-driven authoring systems are often easy to use, but may only be suited to creating stand-alone courses, do not provide a flexible instructional environment (they utilize a relatively limited repertoire of templates), and may not integrate with learner registration and tracking systems. A teacher may user such a system to quickly create a course based on a template, but the course may not communicate student performance to the school's registrar and updating and reusing the course at a later time may be made difficult by the absence of a central file repository, the rigidity of the templates, the need to use a specific tool to edit the course, and/or the use of file formats which are not easily edited. Courses created through such systems are not generally re-sold to others.

The LCMS-based systems are generally more complex, often require dedicated support staff, and frequently instructors must rely on trained course designers and system experts to design a pedagogical and instructional interface around the instructor's content. User roles may exist in such systems, including roles such as “editor,” “administrator,” and “learner,” and elearning courses created through such complex systems generally require the LCMS application to be present as the content is utilized by learners. For example, the LCMS very often dynamically renders content as a given “course” is being delivered to the learner. While a downstream user may be granted the rights of “administrator” or “editor” with respect to the course, such rights will apply wholesale; the downstream user of the LCMS-based course will step into the shoes of the original course author and must be prepared to deal with all of the complexity of the LCMS overall as well as that of the specific course.

As elearning has developed, standards have been created to define communication with LMS, the packaging of instructional content into transferable “learning object” files and the sequencing of learning objects. Standards of note include the Sharable Content Object Reference Model (“SCORM”), published by the Advanced Distributed Learning Initiative of the United States Secretary of Defense and the guidelines published by the Aviation Industry Computer-Based Training Committee (“AICC”).

Required is a elearning course authoring system which offers a collaborative role-based course creation tool with features used by sophisticated publishers of elearning courses combined with a system which allows publishers to syndicate the “hybrid elearning courses” to consuming organizations; the consuming organizations may then customize the hybrid courses through a web-based interface controlled by the publisher. Depending on the level of sophistication of the consuming organization and the relationship between the consuming organization and the publisher, the web-based interfaced and the options presented to the consuming organization may be simplified, such that only portions of the “hybrid elearning course” are editable. In this way, downstream purchasers may customize an elearning course with sophisticated features, but without necessarily having to develop expertise in an LCMS. An elearning course which includes selected portions which may be edited by a consuming organization downstream of a publisher is referred to herein as a “hybrid elearning course.”

### SUMMARY

This summary is provided to introduce a selection of concepts in a simplified form that are further described below in the detailed description. This summary is not intended to identify key or essential essential features of the claimed subject matter, nor is it intended to be used to limit the scope of the claimed subject matter.

Generally stated, the disclosed invention is directed to a method and system which allows publishers to create hybrid elearning courses and to publish the courses to a variety of environments including to an LMS, a web interface, or a CD-ROM. Through a “syndication” process, the hybrid elearning courses are associated with consuming organizations downstream of the publisher; such consuming organizations and/or roles within such organizations may be allowed to edit or customize those portions of the courses which have been labeled as “consumer editable.” The publisher may, for example, allow instructors or others within the consuming organization to add, delete, or modify case studies to make the course more pertinent to the consuming organization's learners while preserving intact other portions of the course which may be required by law or a certification body. The publisher may also allow the consuming organization to apply the consuming organization's graphics, colors, trademarks, slogans and similar to the course and/or to the “skin” of the player which renders the course. The hybrid elearning course may be packaged and published according to industry standards, allowing the customized course to operate within an LCMS hosted by a third party, by a publisher, and/or by the consuming organization. Alternatively, the elearning course may be published to a web interface (hosted, or otherwise) or to a CD-ROM or other stand-alone file store.

### BRIEF DESCRIPTION OF THE DRAWINGS

FIG. 1 depicts an exemplary network and device diagram in and through which systems and methods consistent with the principals of the invention may be implemented.

FIG. 2 depicts an embodiment of the CourseAvenue system comprising components and sub-components, including exemplary database tables, and fields within such tables.

FIG. 3 depicts a functional block diagram of an embodiment of the CourseAvenue system comprising components and sub-components as well as certain third party components.

FIG. 4 depicts an elearning course as viewed within the “studio” component, comprising sub-components and exemplary database tables and fields.

FIG. 5 depicts a block representing the analyze component of the CourseAvenue system and exemplary database tables and fields used by such component.

FIG. 6 depicts a block representing the environment component of the CourseAvenue system and exemplary database tables and fields used by such component.

FIG. 7 depicts a block representing the media component of the CourseAvenue system and exemplary database tables and fields used by such component.

FIG. 8 depicts a block representing the syndication manager and deliver components of the CourseAvenue system and exemplary database tables and fields used by such components.

FIG. 9 is a table of roles, the organization unit associated with the role, and a short description of the role's permissions.

FIGS. 10.1-10.3 is a table of permission names and a short description of the permission.

FIG. 11 is a flowchart depicting an example of an interaction between a user and a course edit session and a course interaction session.

FIG. 12 is a flowschart depicting an example of an interaction in which team assignments and permissions are edited and in which a course is syndicated.

FIG. 13 depicts a functional block diagram of an exemplary computing device that may be used to implement one or more embodiments of components of the invention.

FIG. 14 depicts an example of a user interface with portions relevant to the editor component.

FIG. 15 depicts an example of a user interface with portions relevant to the syndicate component.

### DETAILED DESCRIPTION

The following detailed description refers to the accompanying drawings. The same reference numbers in different drawings identify the same or similar elements and/or components. The following detailed description is for the purpose of illustrating embodiments of the invention only, and other embodiments are possible without deviating from the spirit and scope of the invention, which is limited only by the appended claims. Certain of the figures are labeled with terms associated with specific software applications or categories of software applications, such as “browser,” “webserver,” or “db,” which is an abbreviation of “database.” The labels and the following discussion use these terms and related terms such as “website” as examples and not as limitations. Equivalent functions may be provided by other software applications operating on general and/or specialty purpose devices. Thus, references in this document to a browser, a webserver, or a database should be understood to describe any software application providing similar functions, operating on suitable computer hardware for such software application, and provided with suitable communication facilities. References to a “network” shall be understood to describe any suitable network capable of providing communication between the other components, such as but not limited to the Internet. The components depicted in certain of the figures represent functional groups; it should be understood that such functional groupings need not exist as discrete hardware devices or software applications and that the functions described as occurring within, comprising, or being provided by a grouping may be provided within or by common or separate physical and/or logical hardware devices and software applications. The functions within and comprising any of the function groupings may be regrouped in other combinations and certain of the functions may be omitted without deviating from the spirit of the disclosed invention.

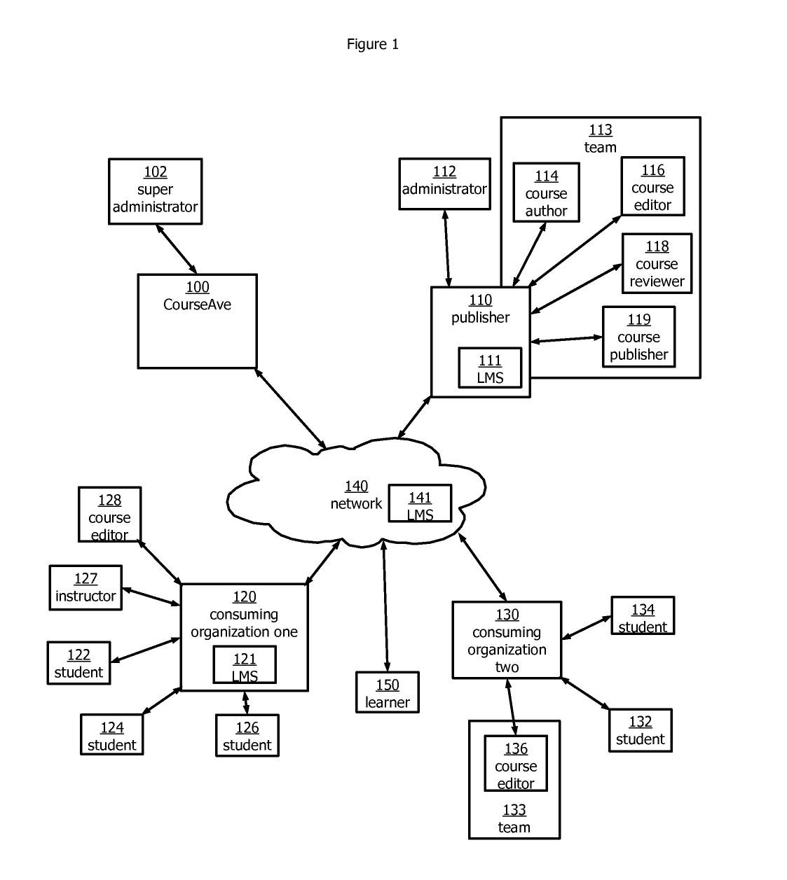

FIG. 1 depicts an exemplary network and device diagram in and through which systems and methods consistent with the principals of this disclosure may be implemented. The lines are meant to represent physical, wireless, or logical network connections. Shown is a network 140, such as the Internet, a private network, or similar. Depicted within the network 140, is LMS 141. LMS 141 should be understood to comprise computer equipment attached and external to the network 140; LMS 141 represents a hosted LMS at a generalized location. As noted above, an “LMS” is a learning management system.

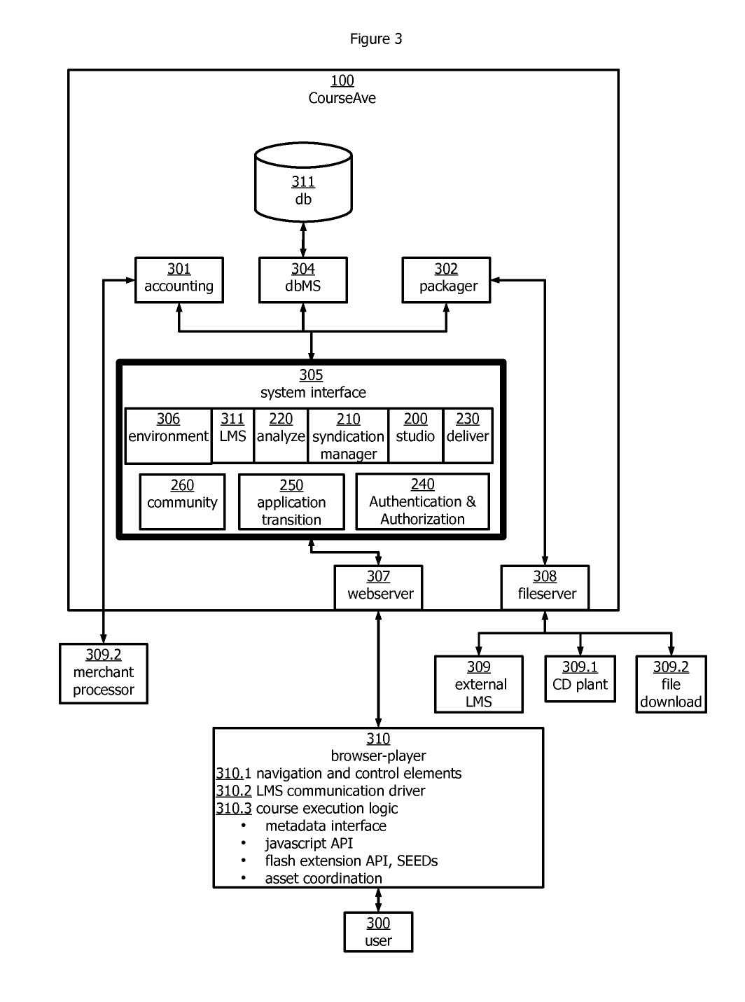

Also depicted is CourseAve 100, which represents any party practicing the methods and utilizing the system disclosed herein. CourseAve 100 is discussed further in relation to FIG. 3. Generally stated, CourseAve 100 provides a web-based collaborative elearning course authoring system and service as disclosed herein. CourseAve 100 is depicted connected to a super administrator 102; additional users in other roles such as those depicted around publisher 110, consuming organizations one 120 and two 130 may also be connected to CourseAve 100.

Also depicted in FIG. 1 is a publisher 110. The publisher 110 may be a party, such as Wolters Kluwer N.V., which provides technical information, training, and other services in relation thereto. The publisher 110 is depicted as being connected to users with roles of an administrator 112, a course author 114, a course editor 116, a course reviewer 118, and a course publisher 119. These roles are presented as examples of roles which users may have. Certain of the roles are presented as being within a team 113. The roles may exist apart from a team and there may be more than one team. Teams and roles are discussed further below, though, generally speaking, the administrator 112 may be understood to be a party which may create teams, which teams have permission to work on one or more courses. The teams comprise roles, the roles being associated with permissions, discussed further below. Users may then be associated with roles on teams. The publisher 110 is also depicted as comprising an LMS 111. As an example used herein, the publisher 110 utilizes the system and services of CourseAve 100 to create, syndicate, and publish elearning courses. The publisher 110 may utilize LMS 111 to provide a hosted LMS service to its own employees and to customers of the publisher, such as consuming organization two 130, which may not operate its own LMS.

Also depicted in figure one are consuming organizations one 120 and two 130. These consuming organizations are consumers of hybrid elearning courses. The consuming organizations may, for example, create or purchase hybrid elearning courses in subjects such as workplace safety, accounting, IT, food service practices, continuing professional education for lawyers, doctors, nurses and the like, or other training and professional educational services. The consuming organization may also belong to a professional organization or have government contracts which require that the consuming organization provide employee training in certain areas, such as nondiscrimination or workplace safety specific to a particular industry. As discussed further herein, the consuming organization (either 120 or 130) may purchase an elearning course from publisher 110 or from CourseAvenue 100, which course is certified to comply with the consuming organization's training requirements. The consuming organization may wish to brand the elearning course with the consuming organization's logo, slogans, corporate colors and the like. The consuming organization may also wish to change examples which may appear in the elearning courses, for example, to describe issues particular to the consuming organization or to use examples drawn from the workplace environment at the consuming organization. Utilizing the methods and/or system disclosed herein, the publisher 110 may provide certification that an elearning course complies with requirements, notwithstanding that the consuming organization is allowed to modify certain components of the course (the publisher 110 can prevent the consuming organization from modifying components of the course which are required for certification).

Consuming organizations one 120 and two 130 differ in that consuming organization two 130 is depicted as not comprising an LMS, such as LMS 121 within consuming organization one 120, in that course editor 136 connected to consuming organization two 130 is depicted as being part of team 133, and in that an instructor 127 is depicted as being connected to consuming organization one 120. Consuming organization two 130 may not utilize an LMS or may utilize a hosted LMS service, such as may be provided by CourseAve 100 or publisher 110. The learners (122, 124, 126 and 132, 134) connected to the consuming organizations may interact with the courses through a network connection to an LMS and/or to a website, and/or through a CD-ROM or other data repository. The learners, editors, and others may utilize a browser-player 310 (FIG. 3), discussed further below, to interact with the elearning courses.

As discussed further below, both consuming organizations are depicted as being connected to a course editor 128, 136, course editor 136 being depicted as part of team 133. The course editor may be authorized by the consuming organization 120, 130 or the publisher 110 to edit certain portions of the elearning courses. A course editor is not required. Not shown, but optionally connected to a consuming organization and optionally part of a team is a course author, administrator, publisher, and other roles comprising other permissions (discussed further below). For the sake of simplicity, a distinction is drawn herein between the publisher 110 and the consuming organizations 120, 130; in practice, a publisher may also be a consuming organization and visa versa.

A learner 150 is depicted in figure one as connecting to the network 140 without first connecting to a publisher or consuming organization. The learner 150 represents learners who may obtain elearning courses from and/or through CourseAve 100 or from another provider, such as publisher 110 or one of the consuming organizations, without connecting through one of the depicted organization's networks. The learner 150 may have other and/or additional roles, such as that of course author, editor, reviewer, administrator, or publisher. Roles are discussed at greater length below.

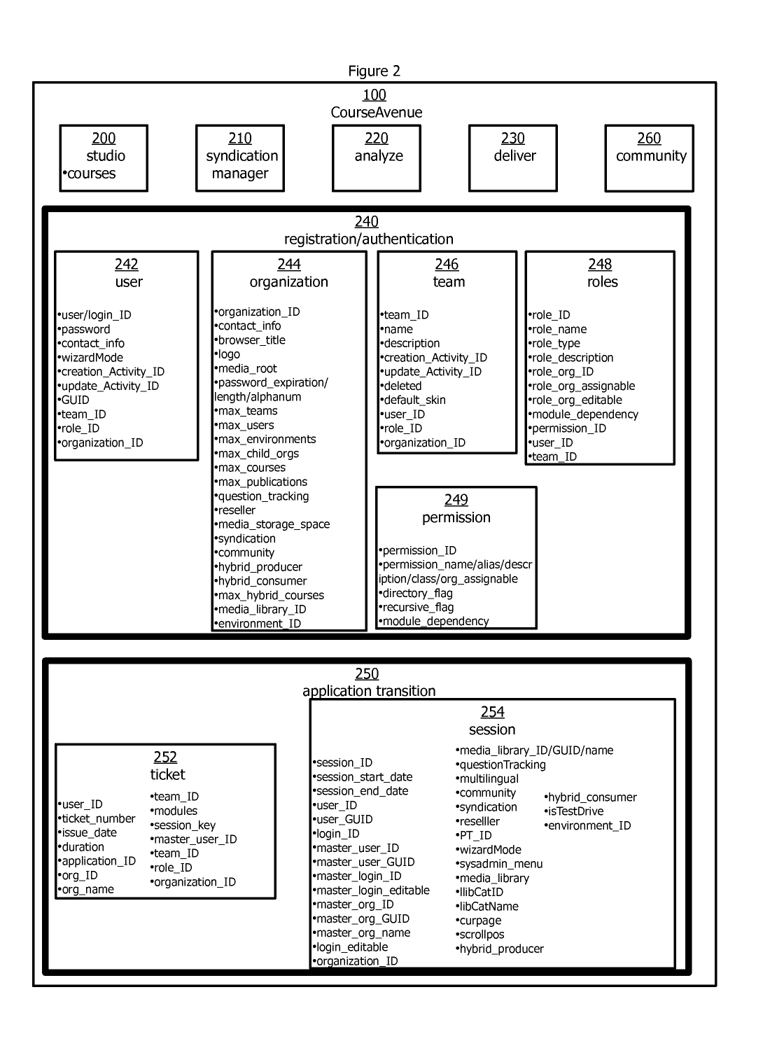

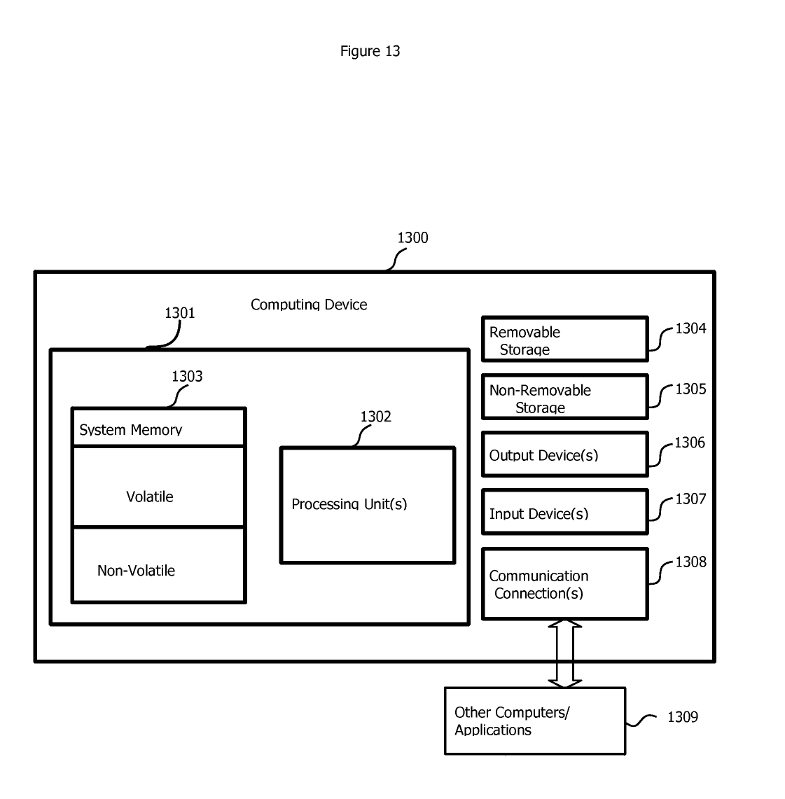

FIG. 2 depicts an embodiment of the CourseAvenue system comprising components and sub-components, including exemplary database tables, and fields within such tables. As noted above, functions are described as occurring within or being performed by certain logical units and/or components; the functions may be re-grouped without deviating from the spirit of the disclosure. These components may be provided by general purpose computers executing instructions for operating systems and application software, as depicted in FIG. 13 and as discussed in relation thereto. The components depicted may utilize software and services provided by more than one computer.

CourseAvenue 100 is depicted as comprising components called studio 200, syndication manager 210, analyze 220, deliver 230, and community 260, discussed further below. Also depicted are components for registration and authentication 240 and for application transition 250. The registration and authentication component 240 provides registration and authentication services at least with respect to users of the CourseAvenue 100 system. The registration and authentication component 240 may provide these services to and/or through other components of the CourseAvenue 100 system. The registration and authentication component 240 is depicted as comprising database tables which may be utilized, modified, and/or accessed (at least and not exclusively) by such component, including tables for users 242, organizations 244, teams 246, roles 248, and permissions 249. Sample fields found in such tables are provided in the figure. The recitation of tables and fields utilized by components in this disclosure is not meant to be exhaustive. These and the other database tables discussed herein may be stored in a relational or other database, such as database 311 in FIG. 3.

Instances of user 242 records may be utilized to store and access information regarding users, such as the user's login identifier and password (and/or certificates or other identifying information), the user's contact information, the date the user record was created or updated (“creation/update_Activity_ID”), a GUID for the user, as well as teams, roles, and organizations associated with a user.

As noted, users may be associated with an organization, such as with publisher 110 or consuming organization one 120 or two 130. Instances of organization 244 records may be used to store and access information regarding organizations. Examples of fields which may comprise an organization record 244 are shown and include information which has an internal purpose, such as an organization identifier, contact information, fields to control password expiration and password requirements (for users associated with the organization), to set a network path for media utilized by the organization, to control the number of teams, users, courses, hybrid courses, child organizations, publications, environments, storage space, whether the organization is a producer and/or consumer of hybrid elearning courses, whether the organization is allowed to syndicate courses and/or to be a reseller of another party's courses and similar. In addition, fields in the organization record 244 may include information used by the browser-player 310, such as a browser title and a logo. Certain of the fields may be used to link to or relate an instance of an organization record 244 with instances of other records; for example,the environment_ID field may be used to link the organization to the environment component 306, discussed further below, and thereby to an environment through which the organization may publish courses—such as to an LMS, to a hosted LMS, to CD-ROM. Similarly, the question_tracking field may be used to indicate that the organization subscribes to services provided by the analyze 220 component.

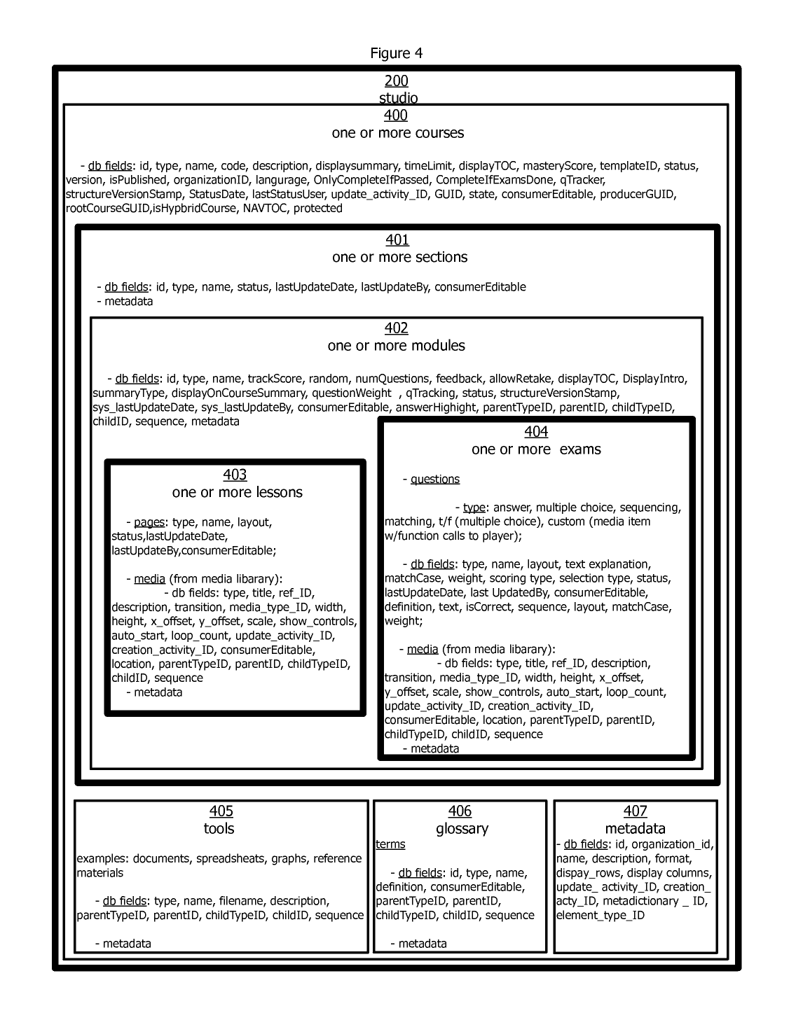

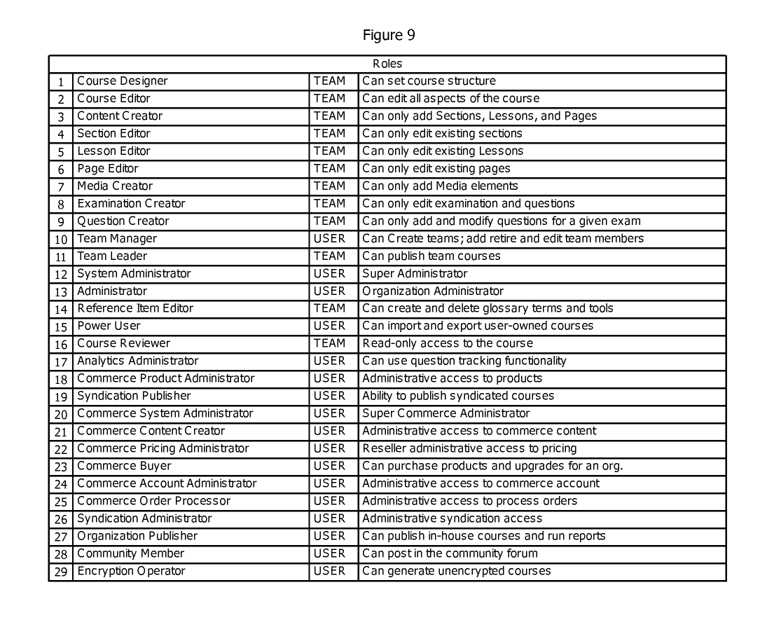

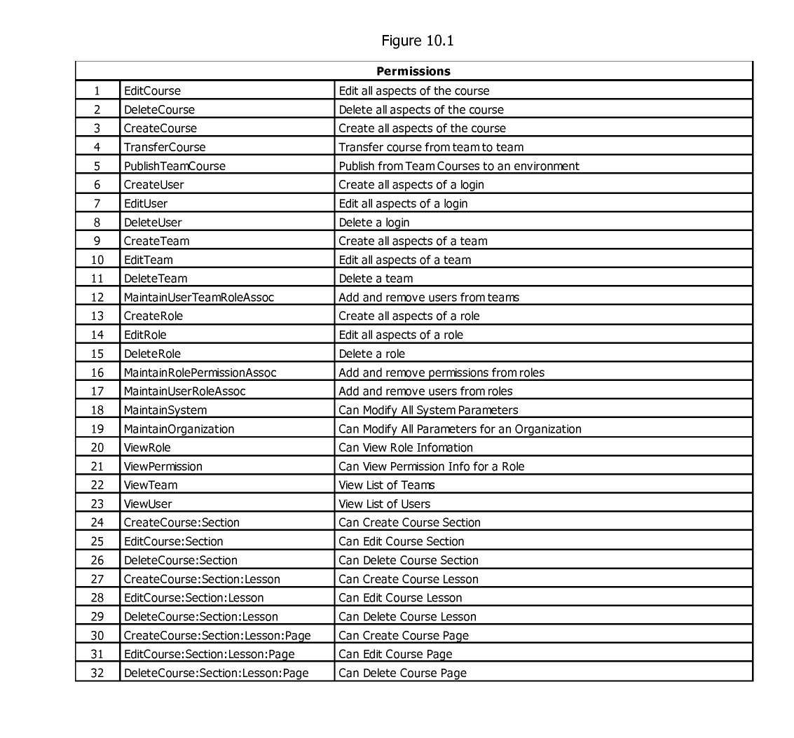

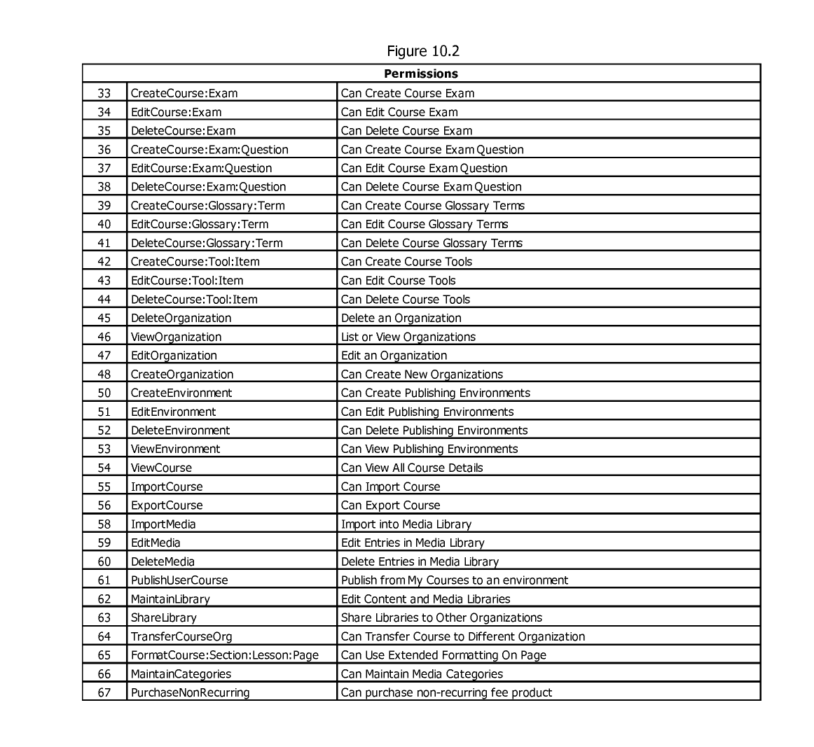

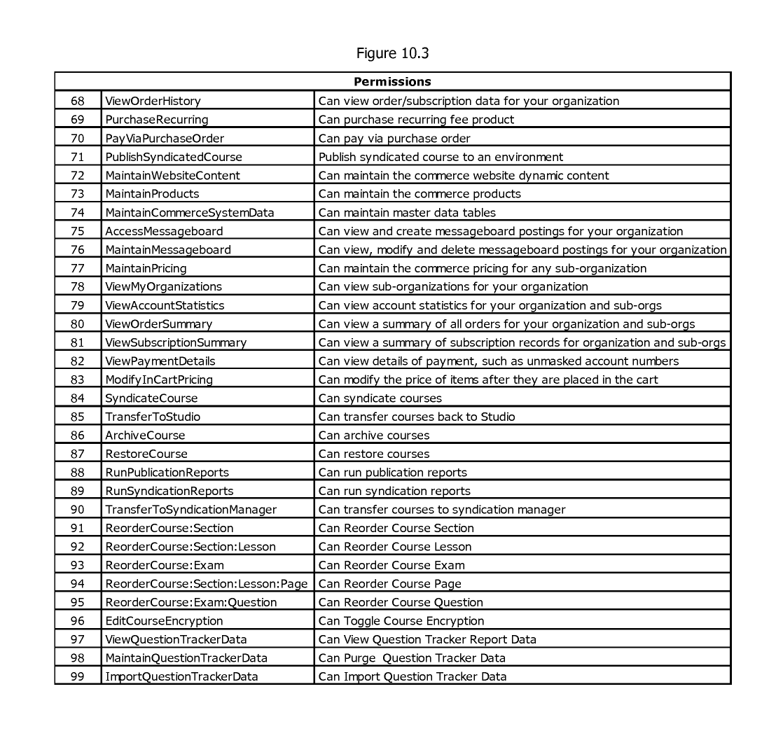

The team record 246 is depicted as comprising fields for team identifier, a team name, description, whether the team has been deleted, and for users, roles and organizations (or associated identifiers) associated with a team. The role record 248 is depicted as comprising fields for a role identifier, name, type, description, organization identifier, whether the role is assignable and/or editable (and/or the field entry may indicate who may assign and/or edit the role), whether the role is dependent upon or associated with a particular module (modules 402 being discussed, below, in relation to FIG. 4) or another sub-component of a hybrid elearning course 400 (see FIG. 4), and which users and/or teams the role may be associated with. Roles are further associated with permissions. Users may may be associated with roles specific to an organization, a team, a course, and/or a portion of a course. The roles presented in FIG. 1 are simplified examples meant to convey the gist of a party's permissions; actual roles may comprise multiple permissions and may not be so neatly categorized. Examples of roles and a text description of the roles are provided in FIG. 9, though additional roles may be defined. The permission record 249 is depicted as comprising fields for a permission ID, a name, alias, description, class, whether the permission may be assigned by an organization to itself or others (certain permissions may be reserved to a parent organization), whether the permission is applied recursively to child organizations, and whether the permission record instance is dependent on a module. Examples of permissions and a text description of the permissions are provided in FIGS. 10.1 through 10.3.

Also depicted in figure two is the application transition component 250, depicted as comprising and/or utilizing the ticket 252 and session 254 records. As discussed further herein, the application transition component 250 may be utilized to transition a user-state between different of the other components, such as between studio 200 and syndication manager 210 or analyze 220 or deliver 230. Transition of a user-state provides a continuous experience, allows a user to leave one process, execute or otherwise interact with another, and then return to the first or a different process without having to repeat steps, such as authorization and authentication, or navigation to a particular webpage, course, and/or course section.

The community 260 component represents a component which provides an interactive forum through which users may discuss the services, specific courses, other users, and the like.

FIG. 3 depicts a functional block diagram of an embodiment of the CourseAvenue system 100 comprising components and sub-components as well as certain components external to CourseAvene 100. In addition to components discussed previously, shown is a system interface 305, which may be a unified application programming interface (“API”) or may comprise the APIs, methods, and classes of the components, supporting operating systems and hardware, contained therein. In addition to the other components of CourseAvenue 100 already discussed, the system interface 305 is depicted as further comprising an environment component 306 (discussed further below) and an LMS 311. The system interface 305 is depicted as connecting to a webserver 307, further connected to a browser-player 310 and a user 300. The browser-player 310 is meant to represent separate software components which may, though are not necessarily, be concurrently present and/or executed by the user's computing equipment; frequently, the components are found concurrently. The browser component of the browser-player 310 comprises browser software, while the player component, such as a Flash™ player, an Adobe Air™ based player, a Java applet, Microsoft Silverlight™ and/or CLI based player or other rich interactive graphical user interface comprising local script/applet execution and/or runtime interpretation utilizing a virtual machine or similar, comprises and/or is supplied with instructions for navigation and control elements 310.1, an LMS communication driver 310.2 (compatible with all standards, such as SCORM and AICC Course Structure File), and course execution logic 310.3, further comprising, for example, a metadata interface, the javascript API, the flash extension API, SEEDs, and asset coordination logic (“assets” comprising the text and media which comprise hybrid elearning courses). The player component may utilize a browser window as a user-interface or may generate its own user-interface and/or window in the user's computing equipment. The browser component of the browser-player 310 may be used to interact with components comprising studio 200, analyze 220 and syndication manager 210, and community 260 while the player component of the browser-player 310 may be used to interact with published courses from deliver 230, the db 311, a CD-ROM or similar. The player component may also interact with studio 200 such as when a user developing a course in studio 200 (using the browser component) selects an option to preview the course in the player, in which case portions of the course under development may be packaged and served to the player component. The player component of the browser-player 310 may be served with a skin separate from a published course. A publisher or consuming organization is not shown in FIG. 3 because the user 300 may be a part of such an organization.

The system interface 305 is also depicted as connecting to a fileserver 308, or similar, to transfer published and syndicated courses to external LMS 309, CD plants 309.1, and similar. The system interface 305 is also depicted as connecting to a database management system 304, which provides database services and further connects to a database 311 (which may comprise multiple databases), which may, for example, comprise a relational database.

Also depicted is a packager 302 in communication with the dbMS 304, the system interface 305, and the fileserver 308. Illustrating the somewhat arbitrary separation of components, the packager 302 could be listed as a sub-component of the deliver 230 component or of another component. The packager 302 serializes data or otherwise prepares a copy of data in the db 311, such as data comprising a syndicated hybrid elearning course or a published elearning course, prior to making the data available through the fileserver 308 or to another environment. The packager 302 may also provide the packaged data back to the db 311 which may then provide it to the LMS 311 and/or the webserver 307, in those cases in which CourseAvenue 100 is hosting the syndicated and/or published elearning course. The packager 302 may also provide the inverse operation of de-serializing data representing an elearning course and populating corresponding fields in database tables (often based on an XML schema, or similar), such as when a published elearning course or a third party elearning course is imported back into the studio 200 component for further editing.

Also depicted in FIG. 3 is an accounting component 301 in communication with the dbMS 304, the system interface 305, and a merchant processor 309.2. The merchant processor 309.2 comprises a bank, credit card processor, or similar payment processor. The accounting component 301 may also invoice customers and handle billing directly. The accounting component 301 updates and receives notification of database entries reflecting transactions for which a charge applies and confirms payments, as necessary, with the merchant processor 309.2. The accounting component 301 allows the system operator to obtain consideration for services, such as charging for the creation, syndication, modification, publication, resale and/or use of an elearning course. Consideration may be obtained based on number of courses, number of users, role of user (or otherwise in relation to permissions provided to a user), amount of storage space used, the time and/or date when a service occurs, amount of data transferred in a given period of time, and similar. Consideration may be obtained from publishers, consuming organizations, learners, or from third parties, such as advertisers. Consideration may be shared among such parties, such as might be the case if a publisher 110 creates and syndicates a hybrid elearning course, a consuming organization 130 customizes the elearning course and publishes it, and if a learner 150 then pays to take the course. The payment from the learner 150 may be kept by one party or may be divided between and/or among any of the other parties, including CourseAvenue 100. In other contractual relationships, payment may be made by the consuming organization 130 and/or the publisher 110 and/or a third party who may, for example, associate advertisements with a hybrid elearning course.

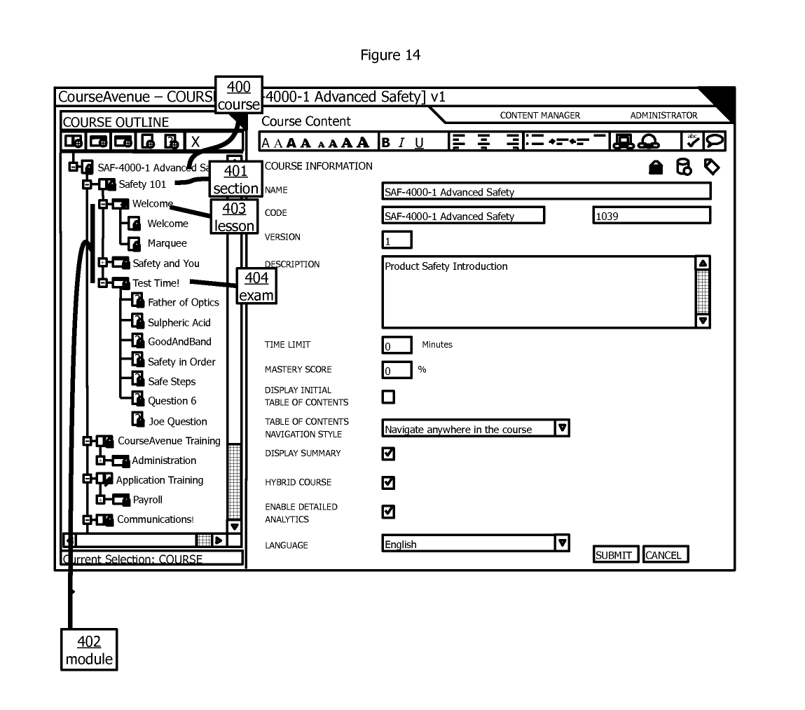

FIG. 4 depicts an elearning course within the studio component 200, comprising sub-components and exemplary database tables and fields. The depiction uses bold and regular lines for the sake of visual clarity in delineating the various components, rather than to indicate any particular significance of one component relative to another. A user 300 uses the browser-player 310 to interact with the system through the webserver 307 and the system interface 305 and, thereby, to create an elearning course 400. Generation of webpages by the webserver 307 may be handle by on-the-fly web page code generation, such as may be provided by Microsoft ActiveX, Active Server Pages (“ASP”) scripts or CGI scripts, or similar, as is known in the art. The webpages presented to the user 300 may be customized by the webserver 307 and/or dynamically by the webpages being processed at the browser-player 310 (by client-side scripts or similar) to present the options which are available to the user 300, based on the use's permissions and navigation of the CourseAvenue 100 system. For example, when a user with permission to edit a course is logged into the system and authenticated, the user will be presented with and/or will otherwise be allowed to see an “edit” link and/or button associated with the course which the user is permitted to edit. If a user is not authorized to edit a portion of the course, then such portions may be visible, but may not be associated with input fields and the like which are required to edit such portions. An example of a webpage with a user interface for studio 200 is depicted in FIG. 14. Permissions are discussed at greater length, below.

In preparing a course 400, the user 300 may select one or more templates, which templates may be addressed to an entire course, or to a section, module, lesson, and/or exam thereof, provide text and/or select media to be used to fill out the templates, set appearance and behavior of title bars, backgrounds, buttons, drop-down lists, and the like, as well as set values for parameters which control other aspects of the course 400, such as the sequence of the course with other courses, the network address of file storage, LMS, and other resources used and/or accessed by the course. Certain of the look-and-feel or “skin” of the course may be created through the use of other tools, such as a tool which creates Flash-readable files and XML; such files may be uploaded to the CourseAvenue 100 system for distribution to players 310 in conjunction with the data representing a course 400. Templates may further be used to drive the generation of the various webpages and user-interfaces served by the webserver 307.

In FIG. 4, a hybrid elearning course 400 is associated with database fields such as identifier, type, name, code, description, GUID, state, and version. The database fields may further comprise entries which indicate how the course 400 may be used, such as fields relating to time limits (which may relate to a time limit within which the course may be taken and/or a time limit to complete the course), whether a table of contents is displayed, what score constitutes mastery of the course, a template identifier for the course, whether the course has been published, an organization ID associated with the course, whether and when the course may be marked as completed, the language for the course 400, whether the course 400 will be tracked by the analyze component 220 and or a network destination to which course interaction should be returned to (the “qTracker” field), whether the course 400 is editable and by who, an identifier for a party which produced the course 400, whether the course 400 is a hybrid course, and whether the course is protected (which may include encrypting the course 400 as well as utilizing authorization and authentication in relation to the course 400).

The course 400 is depicted as comprising one ore more sections 401, each of which may comprise one ore more modules 402. The modules 402 may comprise one ore more lessons 403 and/or exams 404. The division of a course 400 into hierarchical sections 401 and modules 402 which are further divided into lessons 403 and/or exams 404 may be modified without deviating from the spirit of this disclosure. Lessons 403 are depicted as comprising pages and media, each of which are depicted with sample fields. Exams 404 are depicted as comprising questions, which questions may be of a type, such as fill-in the answer, multiple choice (including true/false), sequencing questions (where objects have to be placed into the correct sequence), matching questions, and customer made questions (which generally comprise a media item and function calls to the browser-player 310). Lessons 403 and exams 404 are further depicted as comprising media, such as audio, video, pictures and similar which may be used in a course 400 and which may be stored in a media library. The media library may be part of the database 311 or may be provided elsewhere. See, again, an example of a webpage with a user interface for studio 200, depicted in FIG. 14.

The course 400 is also depicted as comprising tools 405, a glossary 406, and metadata 407. The tools 405 may comprise reference materials, documents, spreadsheets, graphs, and the like which a leaner may wish to access and/or utilize while interacting with a course 400. The glossary 406 may comprise defined terms which may be relevant to the course 400. Metadata 407 may be provided as a separate table as shown in FIG. 4 and may also be provided as a metadata field in the tables for each of the components. Metadata may be used for a variety of purposes, from information regarding the course (such as keywords used in the course) to controlling the skin and browser-player 310 to interacting with an LMS. Metadata may be associated with any component of a course.

As with the course 400, itself, a “consumerEditable” field may be present in the database table for each of the course 400 components, which field may indicate whether the component is editable by a consumer and, if so, the identity of the party and/or role which may perform the edit may further be embodied in the value stored in this field.

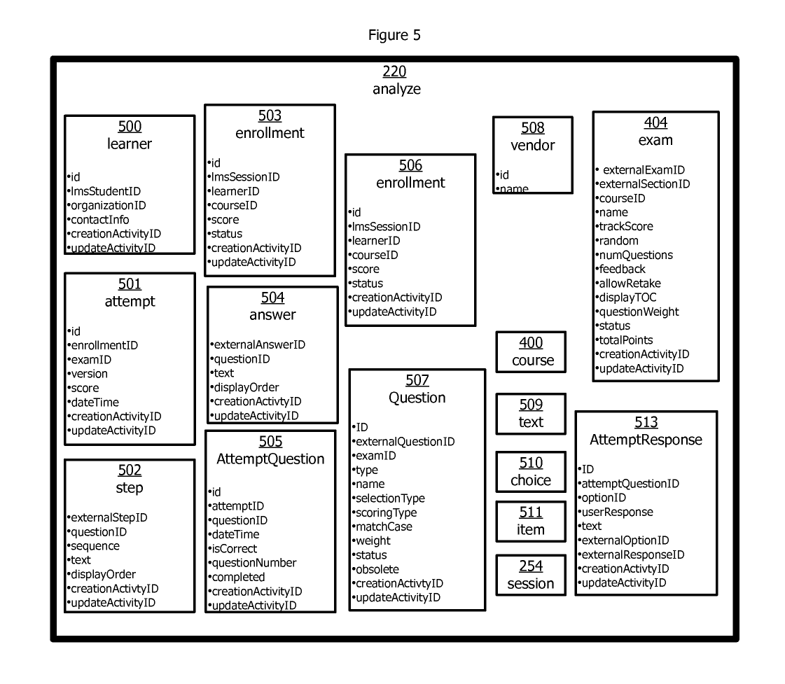

Additional tables may be part of a course 400 and/or a course 400 component. For examples, tables representing different question types (“text 509,” “choice 510,” “item 511”) are presented in FIG. 5 with respect to the analyze component 220.

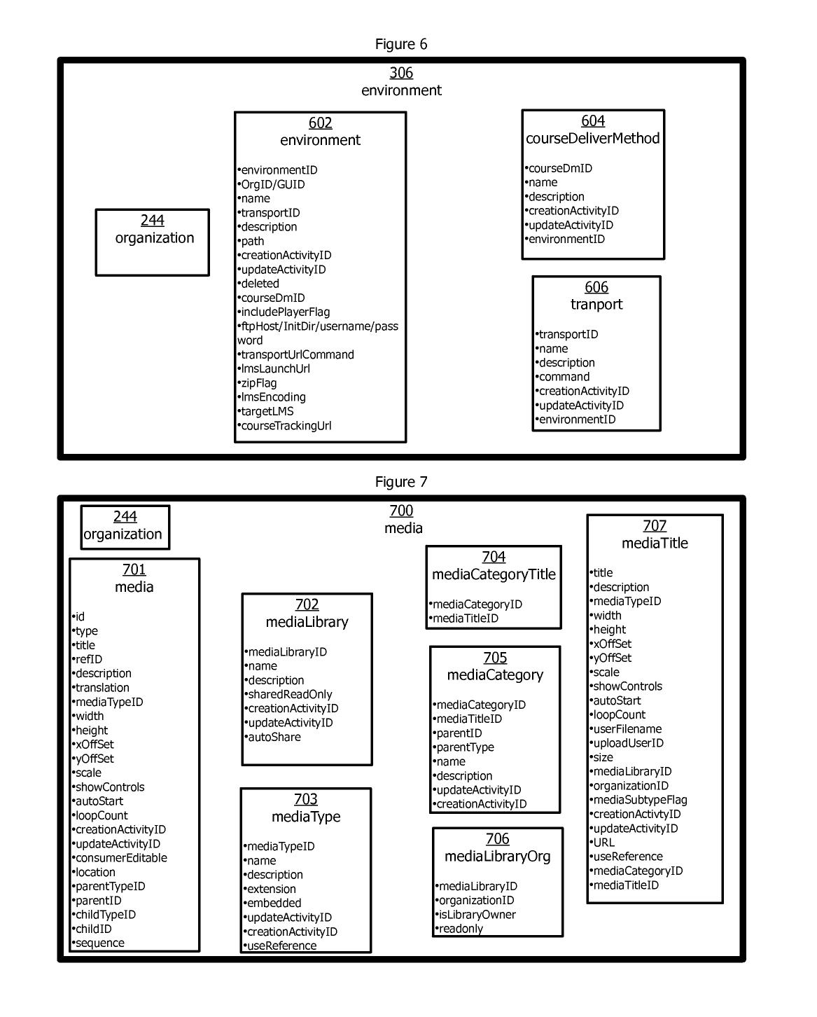

FIG. 6 depicts a block representing the environment component 306 of the CourseAvenue system and exemplary database tables and fields used by such component. The environment component 306 may be used to manage the computing environments through which courses 400 may be accessed and published, such as through an LMS (whether hosted in CourseAvenue 100 or provided by a third party), through a website, including an website accessed through the webserver 307, and/or through delivery of a file in a download and/or in physical media, such as in a CD-ROM or DVD. As an example and not as a limitation, the ability to of an organization to publish courses 400 to a specific type of environment or to more than one environment may be a permission for which consideration is paid. In addition to the operator of the CouseAvenue system 100, a publisher may control the environments which are available to a consuming organization.

FIG. 5 depicts a block representing the analyze component 220 of the CourseAvenue system 100 and exemplary database tables and fields used by such component. The tables utilized by this component may the same as those presented elsewhere, such as the “session 254,” course 400, and exam 404 table. However, these as well as the other tables presented in this figure may be generated from such tables and/or from data representing or originally derived from such tables, such as by de-serializing data comprising a published course. The analyze component 220 is used to analyze or process assessment algorithms which may have been defined in the course creation process, learner interaction with courses 400 and to produce summary information and reports related to such interaction. The reports may include information regarding the number of questions completed correctly by one or more students, the answers provided by one or more students, the time the learner spent on specific questions and/or in interacting with specific portions of the course, and similar. The reports, for example, may be sent to a school's registrar, a human resources department, and/or to an LMS. Completion of a course 400 may be required before a subsequent course 400 may be taken.

FIG. 7 depicts a block representing the media component of the CourseAvenue system and exemplary database tables and fields used by such component. The media component 700 may be used to manage media which occurs in courses 400, such as pictures, video, audio and the like. The media component and database fields used by such component may determine whether media is editable and by whom, what file formats may be used, whether the media is read only or subject to other restrictions, where the media is stored (whether in the database 311, in a database hosted by a publisher or a consuming organization or in a third party database), and similar.

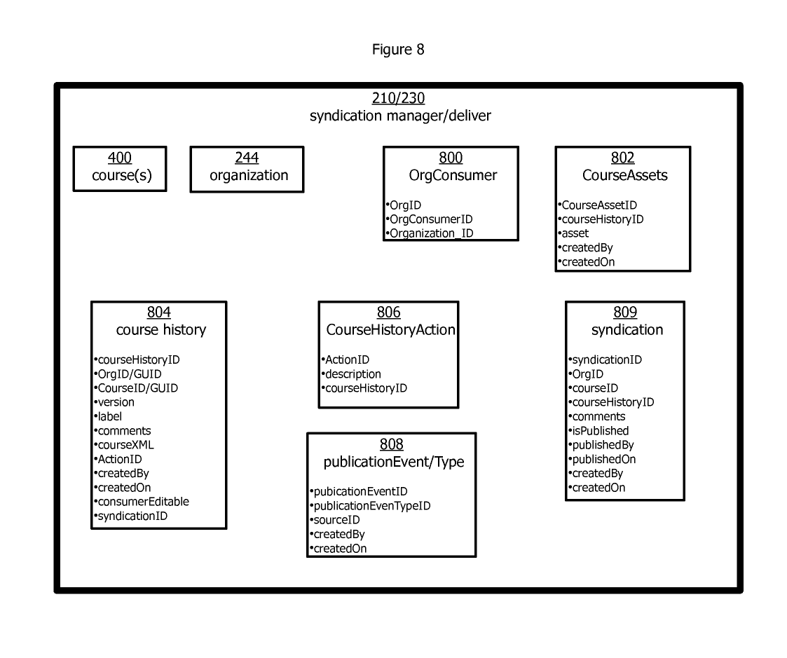

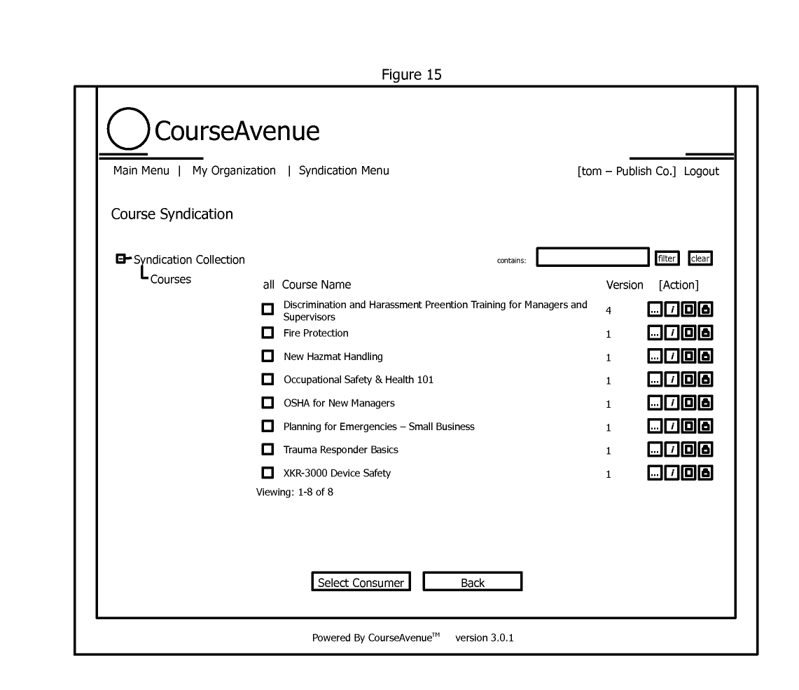

FIG. 8 depicts a block representing the syndication manager and deliver components of the CourseAvenue system and exemplary database tables and fields used by such components. These components may be used by a publisher to indicate that a course is syndicated and, if so, to which organization. These components may further be used to serialize or to cause the packager 302 to syndicate the data comprising a course and to make such data available through environment 306. The act of associating a course with an organization and of serializing the data comprising a course 400 being referred to herein as “syndication” of a course. An example of a webpage with a user-interface for the syndication manager 210 is depicted in FIG. 15; please note the “select Consumer” button at the bottom of the page.

FIG. 9 is a table of roles which may be available in an implementation of the CouseAvenue system 100, the organization unit associated with the role, and a short description of the role's permissions. As may be observed from the table, the roles may be associated with a user as a member of a team or may be associated with a user without regard to team membership. The short description of the role's permissions summarizes a set of permissions which may be associated with a role. A user may be assigned multiple roles. One or more teams composed of roles may be associated with specific courses and/or with an organization. Teams may be managed by an organization and/or a parent organization and by specific users and/or roles within such organizations. The relationship of a user to a role may be static, such that modification of the role's permissions after the user is already assigned the role does not change the user's role's permissions or dynamic, such that modification of a role is applied to all current as well as future users associated with the modified role. As discussed above, the permissions associated with a user—whether through membership in an organization, a team, and/or a role—may be used to determine the webpages presented to the user 300, the dynamic modification of such webpages by the browser-player 310, and otherwise to determine the options which are available to the user 300 through the CourseAvenue system 100. Association of users 300 with role-based permissions is accomplished through the database tables, discussed above, which represent organizations, users, roles, and permissions. Modification of such database tables may be accomplished through direct access to the database 311 and/or through manipulation of the system interface 305 as accessed through a webpage served by the webserver 307.

FIGS. 10.1-10.3 is a table presenting examples of permissions and a short description of the permission. Additional permissions may be created by associating a control and/or a view of a course 400, a component thereof, and/or of the CourseAvenue system 100 (including all elements of the system interface 305) with a permission and creating a database entry corresponding to the permission. In an embodiment certain users 300 may be associated with a permission which allows the user 300 to create new roles composed of permissions while CourseAve may reserve for itself or may grant rights to users 300 the ability to create permissions. Permissions may then be implemented by requiring that a user be associated with a permission before the user is allowed to access and/or utilize the control and/or view and/or to require such a user-permission association before data, a function call, or other parameter value is accepted from a user.

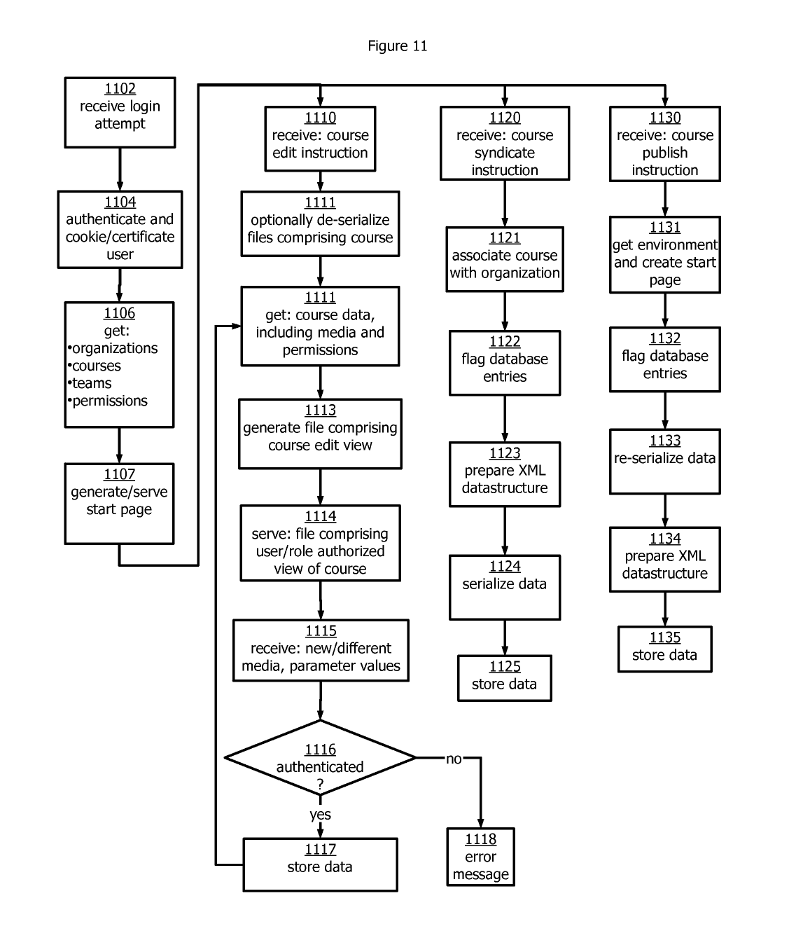

FIG. 11 is a flowchart depicting an example of an interaction between a user and interactions in which a course is edited, syndicated, and published. At step 1102, a user 300 attempts to login to the CourseAvenue system 100. At step 1104, the user 300 is authenticated, such as through a username and password and/or certificate or other code present in the user's computing device and/or browser-player 310, and a cookie and/or certificate or other code is served to the user 300. The cookie, etc., may be used at later steps to confirm the identity of a party who has sent data to the system 100. At step 1106, the database 311 is accessed to obtain the organizations, courses, teams, roles, and permissions associated with the user 300. A webpage, swf file, or similar start page is generated and served at step 1107 which, when rendered by the browser-player 310 or similar shows, for example, the courses, organizations, etc., associated with the user as well as the controls which may be available to the user. The player's view of the start page may be customized with a skin comprising graphical and control elements unique to the user's organization, team, role, etc.

At step 1110 a course edit instruction has been received from a user. If the course edit instruction is in relation to a syndicated course, and if the syndicated course has not yet been de-serialized and corresponding database entries been created for the course 400 (which entries are associated with the user's organization), then step 1111 may include an additional step in which one or more files comprising serialized data comprising a course 400 is or are accessed and de-serialized, with corresponding database entries being created and stored in the database 311. The course 400 XML and/or entries in database tables associated with the course 400 are obtained at step 1112, including the media and permissions associated with the course (which may be role and/or organization associated). At step 1113 the course 400 view file is prepared, based on the permissions and the parameter values obtained at step 1111. For example, if the course 400 has been syndicated and the publisher 110 has provided that only certain pages of a lesson 403 may be edited, then, assuming the user 300 interacting with the course 400 has a role (FIG. 9) with permissions 249 to do so (FIGS. 10.1 - 10.3) then the course 400 view file, when rendered by the player and/or browser 310 will, for example, only present an “edit” button, link, or function to the user 300 in relation to the certain pages of the lesson 403. At step 1114 the file comprising the course 400 view is served. See, for example, FIG. 14. The browser-player 310 may passively present the information provided by the webserver 307 or the player 310 may process the file in conjunction with the cookie or other code served in step 1104, skin files present on the browser-player 310, and similar to present the user 300 with the user's permission-authorized view of the course 400. At step 1115, new and or different media, text, and/or parameter values are received from the user 300. The data received from the user 300 may be authenticated and authorized relative to the user's permissions at step 1116. If confirmed, the user 300 data may be stored at step 1118 or, if not confirmed, an error message optionally returned at step 1118. Following step 1117, the system may return to step 1112 to obtain the updated course 400 data and to continue with the interaction until the user 300 exits the course editing routine.

At step 1120, an instruction is received from a user 300, such as the administrator 112 or course publisher 119 or another user associated with the publisher 110, which user 300 has team and/or user permissions to syndicate a course 400. See, for example, FIG. 15. The instruction and/or subsequent data from the user 300 may indicate the organization(s) with which the syndicated course 400 is to be associated and, at step 1121, the course 400 is associated with the organization. Users and/or teams within the organizations with which the course 400 is associated may be allowed to modify the course 400, according to the permissions set for the course 400. At step 1122 the database entries corresponding to the course are flagged to create a snapshot of the course 400 (so that the course 400 may continue to be edited, independent of the syndicated course) and at step 1123 an XML or similar datastructure is prepared based on the database entries and a schema. At step 1124 data comprising the course 400 may be serialized into one or more files and at step 1125 the files comprising the serialized data may be stored.

At step 1130, an instruction is received to publish a course 400. The course 400 may be a syndicated course or a course which has been created but has not yet been syndicated. If syndicated and if this step has not already been performed, a step similar to step 1111 may be performed to de-serialize files comprising the course (as discussed above). At step 1131 the environment 306 to which the course 400 is to be published is obtained and, if necessary, a start page appropriate to the environment 306 is created. A start page appropriate to the environment 306 is, for example, one which includes parameter values unique to the environment 306, such as the network address of an LMS, if the environment is an LMS, or parameter values which will create hyperlinks addressed to local files in the case of an environment which is a CD-ROM or similar. At step 1132 the database entries comprising the published course 400 are flagged to create a snapshot of the published course. At step 1133, and to the extent necessary, the data comprising the course is serialized and/or re-serialized into files, for example, to decompose the course 400 into smaller files which may more easily be transferred over the network 140 and processed by the browser-player 310. In conjunction with and/or as part of serializing the data into files at step 1133, at step 1134 an XML datastructure or similar may be prepared. At step 1135 the file or files comprising the published course are stored, for example in the database 311 (where the LMS 311 and/or webserver 307 may access them) and/or on the fileserver 308.

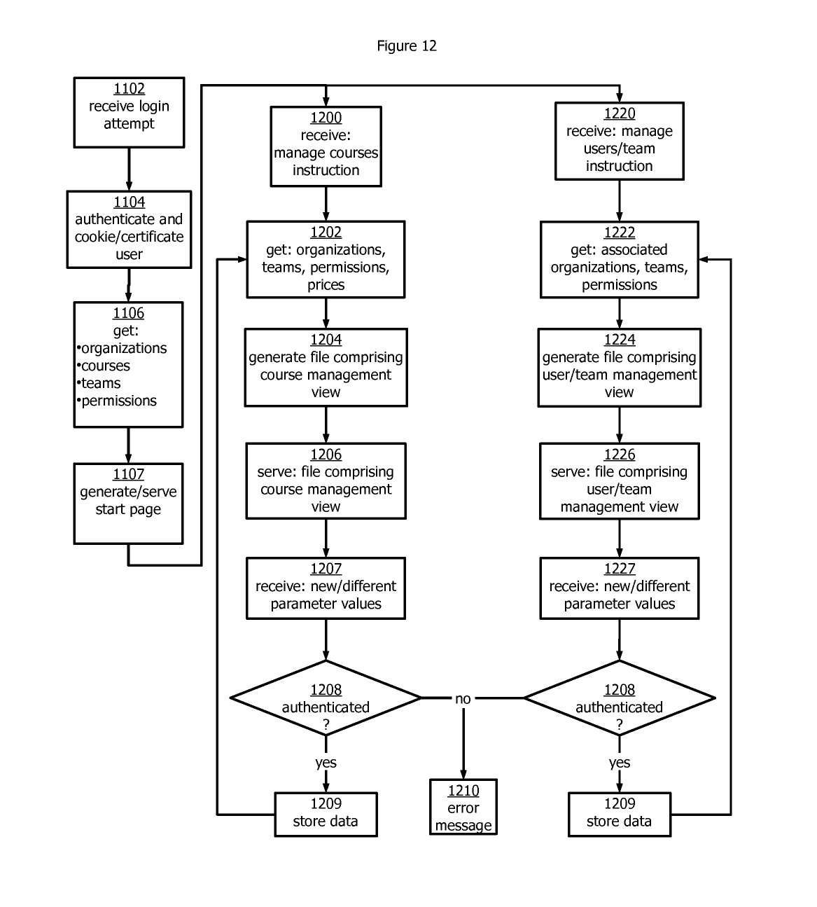

FIG. 12 is a flowchart depicting an example of a process in which courses or users and/or teams are managed. The flowchart begins with steps 1102 through 1107, which may be substantially similar to those described with respect to FIG. 11. At step 1200, an instruction is received which indicates that a user 300 is managing a course 400; the course 400 may be in the process of being created or it may be a syndicated or published course 400. Management activities with respect to a course 400 may include changing the title, a course skin associated with the course 400, changing the amount charged for access to and/or use of the course (whether as a consuming organization, a reseller of the course, a learner using the course, etc.), changing the sequencing of the course with respect to other courses in an LMS, changing the organizations, teams, users and/or permissions associated with the course 400, or changing other aspects of the course 400 which do not require invoking the studio component 200. It should be noted that management of the course 400 may overlap with other functions and/or components of the CourseAvenue system 100; “management” of the course 400 may include functions not accounted for elsewhere and/or functions which a user 300 may simply expect or desire to be grouped together, whether or not such functions may also be provided for elsewhere or whether or not such functions are provided across various of the components of the CourseAvenue system 100. As noted elsewhere, the functional groupings ascribed to the components may be reorganized and regrouped without deviating from the spirit of the invention. As noted above, transition of a user 300 between different of the components may be facilitated by the application transition component 250, which creates one or more records comprising a user-application interaction state.

Step 1202 depicts getting data regarding the organizations, teams, users, permissions, prices, and other parameter values associated with the course 400 and/or associated with the user 300 and/or the user's organization and which are available to be added and/or changed and/or associated with a course 400 through the manage course process. At step 1204 a file comprising the course management view is generated, based on the permissions of the user 300 who made the request at step 1200. Much as noted above with respect to step 1113, if the browser-player 310 passively displays the course management view file, then the file will contain only the text, buttons, links, or other interactive components which the user is authorized to view and/or use; alternatively, if the browser-player 310 is configured to render only those portions of the file which the player's user is authorized to view and/or use, then the course management view file may contain more information and options, which information and options are presented to the user 300 based on the player's local data regarding the user's authorization. Similarly, the file comprising the course management view may be prepared to contain more or less information depending on the extent to which the browser-player 310 is used to remotely perform certain user interactions and operations, such as navigating menu choices, completing input forms, and the like.

At step 1206 the file comprising the course management view is served to the user 300 and at step 1207 new and/or different parameter values are received from the user 300. The parameter values implement and/or represent management of the course, as discussed above. At step 1208 the new and/or different parameter values are authenticated and, if authenticated, are stored at step 1209; if not authenticated, then an error message or similar may be generated 1210. The process may then, for example, return to the generation and serving of the start page at step 1107 or to step 1202 where the management related data associated with the course is obtained.

Step 1220 depicts receiving an instruction from a user regarding management of user and/or a team. Management of users and teams generally refers to managing the members of a team by associating a team with roles, by associating the roles with permissions, and by associating users with the roles; it may also refer to managing permissions which are associated with users independent of such user's role in a team. As noted above, management of users and teams may overlap with other processes and components, inasmuch as, for example, association of a course with a team may also be performed though the manage course process described above, beginning with step 1200.

At step 1222 the organizations, teams, permissions, users and other data relevant to the user and/or team are obtained. As step 1224 a file is generated which file comprises the user/team management view. At step 1226 the generated file is served. At step 1227 new and/or different parameter values are received from the user. The new and/or different parameter values may change the composition of roles on a team, may change the permissions assigned to roles, and may change the users associated with different roles on different teams. As noted elsewhere, a user may be assigned to different roles on different teams and the same or different teams may be associated with different courses and/or organizations. At step 1228, the received parameter values may be authenticated, the values may be stored at step 1229 or an error message may be returned 1210. The process may then return to 1222 or a another step to continue the user's interaction with the system 100.

FIG. 13 is a functional block diagram of an exemplary computing device 1300 that may be used to implement one or more computers used in or by the system and executing instructions embodying the methods described above. The computing device 1300, in one basic configuration, comprises at least a processor 1302 and memory 1303. Depending on the exact configuration and type of computing device, memory 1303 may be volatile (such as RAM), non-volatile (such as ROM, flash memory, etc.) or some combination of the two, such as programmable ROM.

Computing device 1300 includes one or more communication connections 1308 that allow computing device 1300 to communicate with one or more computers and/or applications 1309. Device 1300 may also have input device(s) 1307 such as a keyboard, mouse, digitizer or other touch-input device, voice input device, etc. Output device(s) 1306 such as a monitor, speakers, printer, PDA, mobile phone, and other types of digital display devices may also be included. These devices are well known in the art and need not be discussed at length here.

Additionally, device 1300 may also have other features and functionality. For example, device 1300 may also include additional storage (removable 1304 and/or non-removable 1305) including, but not limited to, magnetic or optical disks or tape. Computer storage media includes volatile and nonvolatile, removable and non-removable media implemented in any method or technology for storage of information such as computer readable instructions, data structures, program modules or other data. Memory 1303, removable storage 1304 and non-removable storage 1305 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 1300. Any such computer storage media may be part of device 1300.

Some or all of the computing device 1300 may be provided by one or more virtual machine instances or similar executing on one or more host computers, which host computers may be may be mounted in racks and networked, such as in a cluster and/or grid computing system or similar, and/or as may be purchased as a service, for example, The Amazon Elastic Compute Cloud (“Amazon EC2”) from Amazon.com, Inc. and/or the Sun Grid Compute Utility from Sun Microsystems, Inc. The computing device 1300 includes system memory 1303 containing operating system and software application instructions which are executed by one or more processing units 1302, which processing units may include a general purpose processor or processors as well as a special purpose processor, such as may be provided by a video card or similar.

FIG. 14 depicts an example of a user interface with portions relevant to the editor component. FIG. 15 depicts an example of a user interface with portions relevant to the syndicate component. Similar user interfaces may be generated by files comprising the course management, user management, and other views discussed above.

1. A method of creating, syndicating, and publishing an elearning course, comprising:
authenticating and authorizing registered users with respect to roles, the roles comprising permissions with respect to elearning courses, instances thereof, components thereof, and e-learning packages;
creating an elearning course by a method comprising:
receiving an instruction from a first user to create and creating a first instance of an elearning course, which first instance comprises tools, a glossary, metadata, a section, which section comprises a module, which module comprises a lesson and/or an exam, which lesson and/or exam comprises text, media and parameter values;
associating a portion of the first instance with one or more “user editable” parameter values, which such “user editable” parameter values indicate whether the portion is editable by a role;
associating the elearning course with a skin;
packaging an elearning course instance as an elearning package, which packaging comprises flagging the database entries required to form a package, serializing the database entries comprising the elearning course, and creating a datastructure;
syndicating an elearning package by a process comprising associating an elearning course instance and/or an elearning package with an organization;
providing a second user with role-based access to a syndicated elearning package;
de-serializing a syndicated elearning package into a second instance of an elearning course;
associating the second instance of an elearning course with new and/or modified text, media and parameter values received from the second user;
publishing an elearning package, including the new and/or modified text, media and parameter values from the second user, to an environment.

2. The method according to claim 1, where publishing an elearning package to an environment further comprises creating an appropriate start page and serializing the database entries comprising the elearning package.

3. The method according to claim 1, where the datastructure is an XML datastructure.

4. The method according to claim 1, wherein the environment comprises at least one of:
an LMS data repository comprising data elements and communication components configured according to the SCORM and/or AICC Course Structure File standards
a website server,
a CD-ROM or other stand-alone file store.

5. The method according to claim 1, further comprising obtaining compensation in exchange for setting a “user editable” parameter value to indicate that an associated portion of the elearning package is editable.

6. The method according to claim 1, further comprising obtaining compensation for creating, modifying, syndicating, or publishing the elearning package.

7. The method according to claim 1, further comprising preparing a record of session-state parameters and utilizing such record to transition a user between the steps of creating an instance, packaging the instance as an elearning package, and/or syndicating and/or publishing the elearning package.

8. The method according to claim 1, wherein publishing an elearning package further comprises publishing an elearning package with parameter values which instruct a course player to return data comprising information regarding learner interaction with the published elearning package.

9. The method according to claim 8, further comprising receiving data comprising learner interaction with the published elearning package and preparing reports derived from such data.

10. The method according to claim 1, further comprising associating an elearning course instance, a syndicated elearning course package, and/or a published elearning package with a team comprising roles.

11. The method according to claim 10, further comprising associating a registered user with a role on the team.

12. The method according to claim 10, further comprising associating the roles with permissions.

13. A computer system to create, syndicate, and publish elearning courses, comprising:
a registration component configured to authenticate users and to authorize authenticated users with respect to roles, which roles comprise permissions with respect to elearning course instances, components thereof, syndicated elearning course packages, and published elearning courses;
an elearning course creation and modification component configured to:
create instances of elearning courses at the direction of a first user, which instances comprise:
tools, a glossary, metadata, and a section, which section comprises a module, which module comprises a lesson and/or an exam, which lesson and/or exam comprise text, media, and parameter values comprising a “user editable” parameter value, and
modify portions of instances of elearning courses associated with a “user editable” parameter value at the direction of the first and/or a second user;
a packaging component for creating an elearning package, which packaging component is configured to:
serialize data comprising instances of elearning courses into an elearning package, and
deserialize an elearning package into instances of elearning courses;
an elearning course syndication component configured to associate an elearning package with an organization;
an elearning course publishing component configured to publish an elearning package to an environment;
a database configured to record and update records according to instructions from the other components of the system;
a webserver configured to provide a web-based interface to components comprising the registration component, the elearning course creation and modification component, the course syndication component, and the publishing component.

14. The system according to claim 13, wherein the elearning course publishing component publishes an elearning package to an environment with parameter values which instruct a course player to transmit data comprising information regarding learner interaction with the published elearning package to the system and further comprising a component to generate summary information based on such learner interaction information.

15. The system according to claim 13, wherein the environment comprises at least one of:
an LMS data repository comprising data elements and communication components configured according to the SCORM and/or AICC Course Structure File standards;
a website server;
a CD-ROM or other stand-alone file store.

16. The system according to claim 13, further comprising an accounting component configured to obtain compensation in exchange for permission to create, syndicate, modify, or publish an elearning course.

17. The system according to claim 13, further comprising a component to prepare a record comprising session-state parameters and to provide such record to the other components to allow a user-session-state to be transferred between such components.

18. The system according to claim 13, further comprising a course player configured to communicate with the website server and to provide a rich interactive user interface through the execution of local scripts and/or runtime interpretation.

19. The system according to claim 18, wherein the course player further comprises instructions for navigation and control elements, an LMS communication driver, and course execution logic.

20. The system according to claim 13, further comprising a user, team, organization, and course management component configured to associate users with organizations and teams, teams with elearning courses, roles with teams, and roles with permissions.
